(19) United States
(12) Patent Application Publication
(10) Pub. No.: US 2002/0178365 A1
(43) Pub. Date: Nov. 28, 2002

(54) Method and system for controlling access to network resources based on connection security

(76) Inventor: Shingo Yamaguchi, Cupertino, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/863,384

(22) Filed: May 24, 2001

(51) Int. Cl. H04K 1/00; H04L 9/00

(52) U.S. Cl. 713/182

(57) ABSTRACT

A method and system for controlling a network, such as a computer network. A computer network connection is established between one or more computers or computing devices and an intermediate device to which network resources are connected. There is a controlling of a level of access of the computer or computing device to the network resources based on the level of security of the computer network connection between the computer or computing device and the intermediate device. Such a controlling may be performed by the intermediate device, a separate firewall device, and/or components of a network operating system or network controlling software. The computing devices are connected to the intermediate device using a wireless connection, although as an alternative a wired connection may be utilized.

### BACKGROUND OF THE INVENTION

1. Field of the Invention

The present invention relates to controlling access to network resources. The invention is more particularly related to controlling the level of access to network resources based on a level of security of a connection to the network.

2. Discussion of the Background

Wireless access to a computer network is known. For example, a user can connect any type of computing device such as a laptop Personal Computer (“PC”) to a network such as the Internet, or an intranet. Common standards for wireless networking are the IEEE 802.11 Direct-Sequence (“DS”) and 802.11b networks. In such networks a level of security of the network may be increased by utilizing Wired Equivalent Privacy (“WEP”) security. Such WEP encrypts the wireless communication in order to prevent easy interception.

WEP encryption, as it is a standard, enables interoperability of wireless networking of hardware from different manufacturers. In order to use such WEP encryption, the user sets the same encryption key in both the end client or laptop computer, and also the access point which communicates with the wireless device. When a user utilizes different wireless networks, the encryption key must be changed to correspond with each network's key. The present inventor has found it may be troublesome to change and remember encryption keys for each network. In order to eliminate the need to change the network encryption or WEP keys, the present inventor has found that it is possible simply to turn off the WEP encryption, but this also turns off the security or encryption provided by WEP security.

### SUMMARY OF THE INVENTION

The present inventor has developed a method of controlling a level of access to network resources based on a level of security of the network connection. While the preferred embodiment utilizes a wireless network connection, a wired or other type of network connection may be utilized. There is an intermediate device connected between a computer and network resources, and a network connection is established between the computer and the intermediate device. There is a determination of a level of security of the computer network connection between the computer and the intermediate device. Based on the level of security of the computer network connection, the computer is allowed to have access to one or more of the network resources.

According to an embodiment of the invention, the network connection between the computer and the intermediate device is a wireless network connection. According to a further embodiment, the wireless network connection conforms to the IEEE 802.11b standard.

The level of security of the computer network connection, according to an embodiment of the invention, is determined by examining whether the computer network connection is encrypted. According to a further embodiment of the invention, the level of security is determined by examining whether the computer network connection is encrypted using Wired Equivalent Privacy (“WEP”) encryption. The network resources to which access is permitted based on the level of security of the computer network connection may include access to a file server, access to the Internet, or access to an email server.

According to an embodiment of the invention, the determination of the level of security of the computer network connection may be performed by the intermediate device itself. The intermediate device can be implemented, if desired, to be a router and to have a firewall function. According to another embodiment of the invention, the controlling of a level of access to network resources may be performed by a network operating system or directory services thereof. Still further, a separate firewall device may be utilized to control the level of access of the computer to the network resources.

### BRIEF DESCRIPTION OF THE DRAWINGS

A more complete appreciation of the invention and the advantages thereof may be obtained by reference to the drawings, wherein:

FIG. 1A illustrates two computing devices connected to an intermediate device which serves as an interface to further network resources;

FIG. 1B illustrates a network containing further network resources to which the computing devices of FIG. 1 may have access;

FIG. 2A is a conceptual block diagram of the intermediate device of FIG. 1A;

FIG. 2B is an alternative embodiment of a conceptual block diagram of the intermediate device of FIG. 1A;

FIG. 3 is a block diagram of the hardware components of the intermediate device;

FIG. 4 is a flowchart showing the operation of the invention; and

FIG. 5 is a firewall device used in one embodiment of the invention which connects the intermediate device in FIG. 1A to the network illustrated in 1B.

### DETAILED DESCRIPTION OF THE EMBODIMENTS

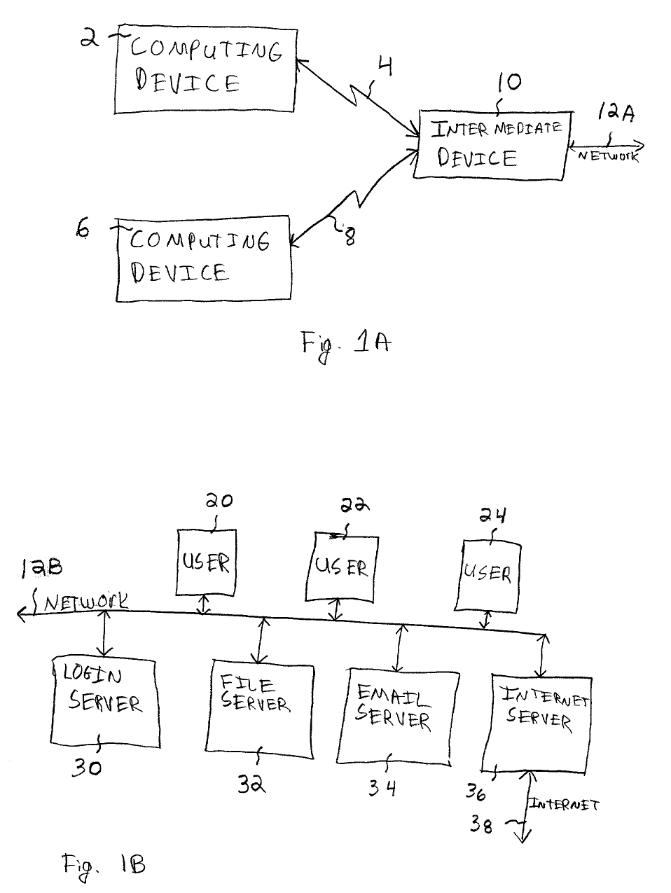

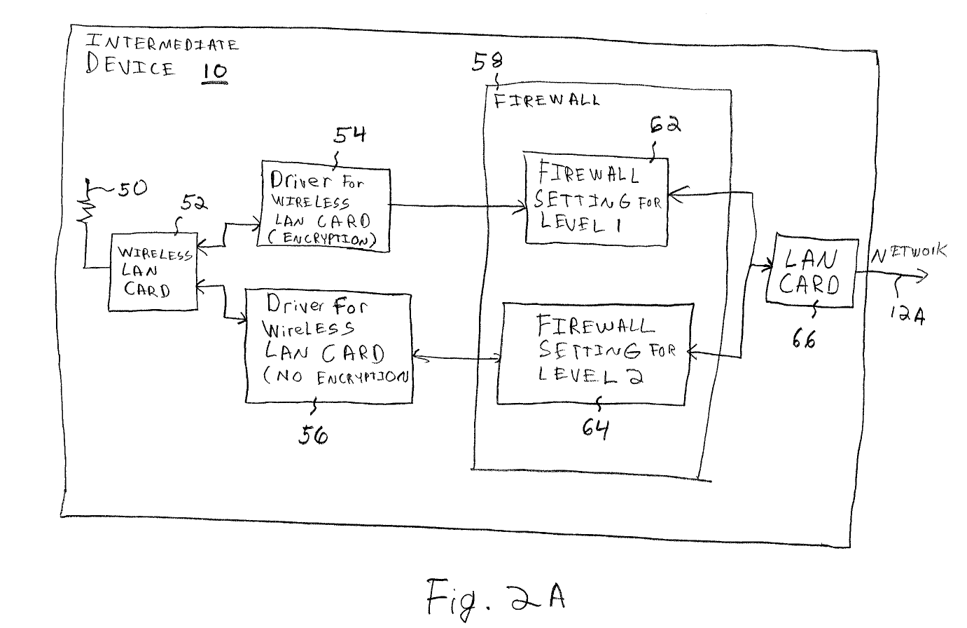

Referring to the drawings, wherein like reference numerals designate identical or corresponding parts throughout the several views, and more particularly to FIG. 1A thereof, there is illustrated a portion of a computer network. A computing device 2 is connected to an intermediate device 10 through a network connection 4, and a computing device 6 is connected to the intermediate device 10 through a computer network connection 8. The computing devices 2 and 6 may be the same or different types of computing devices, and may be implemented using a variety of hardware. The computing devices 2 can be any type of devices which compute (e.g., computers). For example, the computing devices 2 and 6 may be implemented using a desktop computer, a laptop computer, a handheld computer, a palm computing device, a personal digital assistant, or even a cellular phone or cellular phone-type device. The computer network connections 4 and 8 may be implemented in any desired manner and according to one embodiment, are wireless computer network connections. In this embodiment, wires are not the only medium to communicate information between the computing devices and the intermediate device, but a wireless communication medium, such as radio frequency, infrared, or ultrasound may be utilized as the computer network connection. A specific wireless type of computer network connection which may be utilized with this invention is a connection which conforms to the IEEE 802.11 standard, and more preferably the 802.11b standard. However, any other appropriate connection, including a wired network connection may be utilized as the network connections 4 and 8.

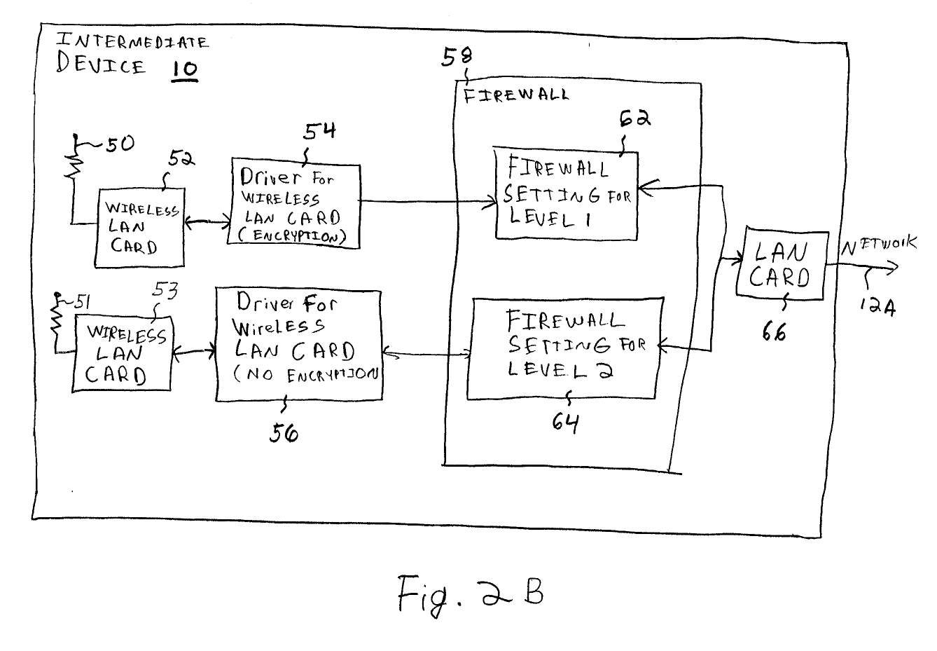

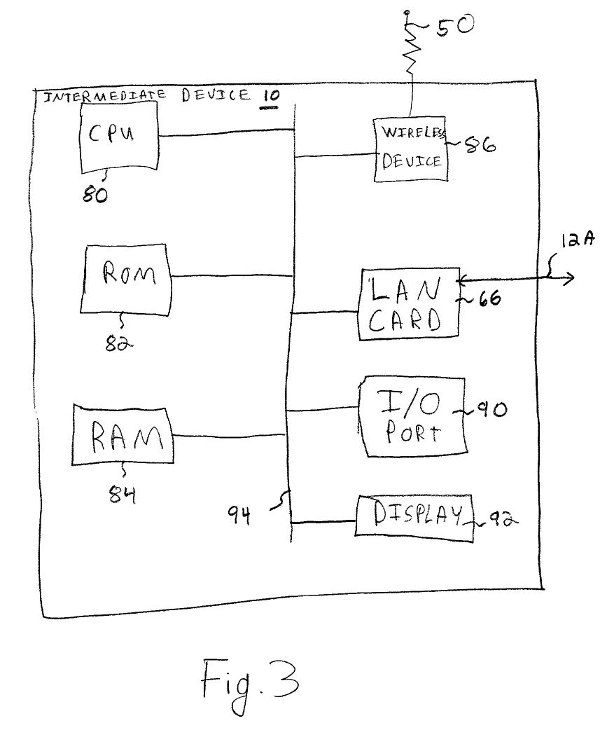

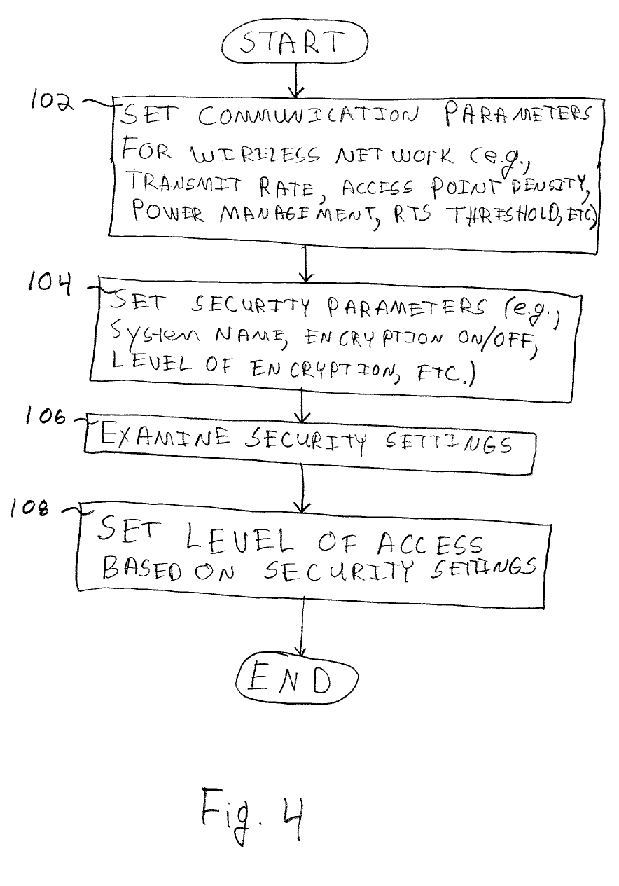

The intermediate device 10 functions as an intermediate or connecting device between the computing devices 2 and 6 and the network 12A, and the components connected thereto. Further information about the intermediate device 10 is explained with respect to FIGS. 2 and 3.

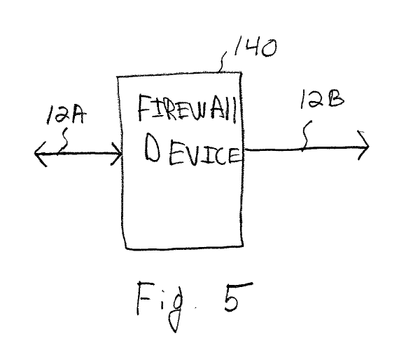

FIG. 1B illustrates a network 12B including various network resources. According to an embodiment of the invention, network 12A of FIG. 1A and network 12B of FIG. 1B are the same network and are directly connected to each other. Alternatively, the networks 12A and 12B are connected to each other through an intermediate device such as by a firewall device (explained with respect to FIG. 5) or by another device such as a hub, bridge, switch, router, or any other appropriate network connecting device. The network 12B has various network resources connected thereto including, for example, a login server 30, a file server 32, an email server 34, and an Internet server 36 connected to the Internet 38.

The login server 30 allows the management of computer and networking resources from a single point of administration, if desired. The login server 30 may be implemented using Novell Directory Services (“NDS”) which is a product for managing access to computer networks. Using NDS, a network administrator can set up and control a database of users and manage them using a directory with a graphical user interface. Using NDS, or the login server 30, users of computers at remote locations, including the computing devices 2 and 6, if appropriate, can be added, updated, and managed centrally. The login operation to the network is typically controlled by a script which is executed or interpreted. As an alternative to Novell Directory Services, Microsoft's Active Directory may be utilized as a directory service. Moreover, any suitable software and/or hardware may be utilized to assist in controlling access to and management of the network resources. While the login server 30 has been illustrated as a separate server in FIG. 1B, and it is possible to implement the directory services or login server functions using a server which performs other functions such as the file server 32, or any other server or resource on the network 12B.

The file server 32 contains files which may be accessed by a user of the computer network 12B, and the email server may be utilized to manage and control email accounts on the network and permit the sending and receiving of Internet email. The Internet server 36 allows access to the Internet 38. If desired, the Internet server 36 may be utilized to allow browsing of the World Wide Web, can allow file transfers using the File Transfer Protocol, and may allow the transmission and receipt of Internet electronic mail messages, for example by the email server 34. While the email server 34 and the Internet server 36 have been illustrated as separate servers, the functions performed by these devices may be integrated into a separate device, if desired. Moreover, any of the servers and resources illustrated in FIG. 1B may be combined into one or more servers or computers.

Also illustrated in the network of FIG. 1B are users 20, 22, and 24. These users may be implemented as personal computers, work stations, or dumb terminals, and have access to the servers on the network 12B. Moreover, the users may have access to or be able to control any of the devices illustrated in FIG. 1A. Moreover, a print server may be connected to the network 12B which controls and permits the printing of information from any of the devices illustrated in FIGS. 1A or 1B, and connected to one or more printers. Moreover, the networks 12A and/or 12B may be implemented as a Local Area Network (“LAN”), may be Wide Area Networks (“WAN”), may be the Internet, or may be an intranet, or any combination of these types of networks.

FIG. 2A illustrates functional components of the intermediate device 10. FIG. 2A, and also FIG. 3, are illustrated with regard to a wireless Radio Frequency (“RF”) connection to the computing devices 2 and 6, although the present invention is not limited to such connections and may be implemented using other types of wireless connections or a wired network connection. In FIG. 2A, the intermediate device includes an antenna 50 connected to a wireless LAN card 52. The wireless LAN card 52 functions to receive and transmit signals to and from the antenna 50, and also utilizes drivers 54 and 56. The wireless LAN card 52 may be controlled by software or firmware, such as the drivers 54 and 56. According to the invention, different levels of security can be used for different communications between the intermediate device 10 and the computing devices 2 and 6. For example, some communications may be encrypted whereas other communications may be unencrypted. To carry out such functionalities, there are illustrated in FIG. 2A the driver 54 which serves as the software or firmware for the wireless card 52 to perform encrypted communication with the computing devices 2 and/or 6, for example. There is also the driver 56 which is illustrated for performing communication which is unencrypted. The encryption may be carried out according to the Wired Equivalent Privacy (“WEP”) encryption standard commonly used in wireless networks, although any other type of encryption or security protection may be utilized. While two separate drivers 54 and 56 are illustrated for encrypted and unencrypted communications, respectively, actual implementation of the invention may use the same driver, if desired, to perform both encrypted and unencrypted communications.

There is a firewall or firewall device 58 which is included within the intermediate device 10 and is a block and structure which carries out the functions of a firewall. This firewall 58 may be utilized to control the network resources to which the computing devices 2 and 6 have access. According to the invention, as explained in further detail below, when the network connection between the computing devices and the intermediate device 10 is encrypted, it may be desired to perform access to all network resources or a more complete set of network resources. In this case, a component or block 62 will provide firewall settings for level 1 access which provides a high level of access to the various network resources illustrated in FIG. 1B. Alternatively, if a lower level of security, such as no encryption is utilized for the connection between a computing device and the intermediate device 10, a setting or function or block 64 is utilized in which the firewall settings is utilized for a lower second level or level 2 access. In this case, the user may have access to a limited set of network resources such as access to the Internet 38 through the Internet server 36, and if desired, access to the email server 34. Access to the file server 32 and/or possibly other resources may be provided only when firewall settings for level 1 are utilized with respect to functional block 62. While the functional block 58 is labeled as a firewall, the restriction to network resources may be implemented using a firewall device, but other devices or functions are possible, in place of the firewall 58, as long as the function of providing various levels of access to the network resources is possible. The firewall 58 is connected to a LAN card 66 which provides an interface to the network 12A.

FIG. 2B illustrates an alternative embodiment of the intermediate device. In this alternative embodiment, in addition to the illustrated components of FIG. 2A, there is an antenna 51 connected to a wireless LAN card 53. Additionally, the wireless LAN card 53 is connected to the driver 56 which operates without encryption. There are illustrated two LAN cards 52 and 53 in this embodiment because the encryption is performed, according to one or more embodiments, by firmware in the LAN cards. Thus, an implementation according to this embodiment utilizes a LAN card 52 for encrypted communications, and a LAN card 53 for unencrypted communications.

FIG. 3 illustrates a hardware block diagram of the intermediate device 10. There is a CPU 80 which may be any general or special purpose microprocessor or processing device. A Read Only Memory (“ROM”) 82 is utilized to store a control program and/or operating system of the Intermediate Device 10. As an alternative to a ROM, there may be utilized a rewritable nonvolatile memory such as a flash memory or an EEPROM, for example, which allows upgrading and modification of the control program of the intermediate device 10. A random access memory (“RAM”) 84 is utilized to store working parameters and variables of the intermediate device 10. A wireless device 86 is connected to the antenna 50 and performs the functions related to the transmission and control of communications and the formatting of communications, if desired. In addition or alternatively, the CPU 80 may perform or assist in the formatting and controlling of the communications. The LAN card 66 provides an interface to the network 12A and may be implemented using any conventional LAN or WAN interface. There is an I/O (input/output) port 90 which allows a keyboard, mouse, serial cable, universal serial bus cable, fire wall cable or other computing device to be interfaced to the intermediate device 10 in order to monitor and/or control the operation of the intermediate device 10. If desired, the intermediate device 10 also includes a display 92 which allows the displaying of the status and communication operations of the intermediate device 10, and may be simply one or more LEDs or a small LCD display. Alternatively, a full size LCD display or CRT may be utilized, if desired. The various components illustrated in FIG. 3 are connected by a system bus 94.

According to one embodiment of the invention, the intermediate device is a router. Thus, routing functions are performed by the intermediate device. Moreover, according to an embodiment, the intermediate device 10 also contains a firewall function. Both the routing and firewall functions may be implemented utilizing software. For example, the Linux operating system has routing and firewall functions in the kernel, and are referred to as IP forwarding. The firewall settings or level of access of the network resources can be individually controlled for the various computing devices 2 and 6 in FIG. 1A. Thus, the level of access or firewall settings for the wireless LAN card 52 can be different for the various computing devices accessing the intermediate device. Alternatively, the present invention can be readily implemented by modifying the software or firmware functions of the D-Link DI-711 Broadband Wireless Gateway/Firewall, described in the DI-711 Production Description and Product Specification, and/or the SMC Barricade Wireless Broadband Router, described in the SMC Barricade Overview, Technical Specs, and User Guide, the disclosure and operation of each is incorporated herein by reference. Moreover, the system of the present invention may be implement, if desired, utilizing any of the teachings disclosed in U.S. Pat. Nos. 5,636,220, 6,167,514, and 6,148,334, and any of the patents or documents cited or referenced therein, all of which are incorporated herein by reference. Further, the intermediate device 10 and the operation thereof may be implemented with the assistance of or utilizing any of the teachings or explanations contained in the RoamAbout 802.11 Wireless Networking Guide, by Cabletron Systems, and any of the standards and components described therein, all of which are incorporated by reference.

A flowchart showing the operation of the invention is set forth in FIG. 4. After starting, step 102 is performed which sets the communication parameters for a wireless network. For example, parameters which may be set include the transmit rate, the access point density which may be utilized when there is more than one intermediate device receiving wireless communications from the computing devices, power management settings such as sleep mode, and RTS threshold parameters which relate to a Request To Send signal. An access point is a device where a wireless device may be interfaced to a wired network. As an example, the intermediate device 10 may be considered an access point. However, the present invention may be applied, if desired, to an all wired network, or an all wireless network, or a combination thereof, and therefore step 102 may be utilized to set the communication parameters for wired communication between the computing devices and the intermediate device 10.

Step 104 sets the security parameters of the connection between the computing devices and the intermediate device 10. Such security parameters may be simply knowing the system name, or the name of the intermediate device or access point 10. Further levels of security may be utilized or set such as encryption which may be according to the WEP standard, for example. Other forms of encryption may be utilized and different key lengths or number of bits may be utilized for the keys to set different levels of encryption. Further, varying types of security parameters may be set, if desired.

Step 106 examines the security settings which have been set in step 104. Alternatively, the security parameters may have been set at a different time, or may be default parameters. The security settings are examined in step 106 in order to determine what level of access the computing devices may have to the network resources. In step 108, the level of access to the network resources is set based on the security settings. For example, when WEP encryption is used, or a higher or some type of encryption or security system is utilized, the computing device having such high level of security may be provided access to every network resource, or a large number of network resources such as a majority of the network resources. Also, when the security level is set to a relatively high level, or encryption is on, for example, access to a file server which is one of the network resources may be permitted. Access to the file server may be denied, unless encryption is turned on, for example. Contrary to the level of access which may be required for the file server, accessing the Internet is merely accessing publicly available resources. Thus, access to the Internet may be permitted regardless of whether the computer network connection, such as the connections 4 or 8 are encrypted or secure. With regard to access to the email server, the system may be set up, as desired, so that the email server may be accessed when the security level is set to encryption or some higher level, or alternatively, the email server may be accessed even when there is no encryption. In an embodiment, the person or computing device accessing the email should only have access to his or her own email account.

Step 106 which examines the security settings and step 108 which sets the level of access based on the security settings may be performed in the same step, may be performed in different steps, may be performed by the same device, or may be performed by different devices. According to one embodiment, the intermediate device, which may be implemented as a router, or a wireless router, may set and control the level of access to the network resources based on security settings. However, other embodiments and implementations are possible, some of which are described below.

According to at least a portion of the above description, controlling a level of access is implemented using the intermediate device 10, and/or firewall functions within the intermediate device 10. However, the controlling of a level of access of the computer to the network resources may also be performed by the login server 30 by itself, or by the login server 30 in conjunction with functions performed by the intermediate device 10. Also, as explained above, the login server 30 may be part of the file server 32, or any other server illustrated in FIG. 1B. When a user logs onto a computer network, directory services such as the Novell Directory Services (“NDS”) may be utilized to control the administration of a computer network, and to control what particular network resources a user has. An alternative directory service which may be utilized is Microsoft's Active Directory, although any other software, directory service, or system may be utilized to control the level of access to the network. The directory services may be considered to be part of a network operating system, or may be separate from the network operating system, if desired. When the network operating system or directory service is utilized to control access to the network or to control a level of access to network resources, the login server or other computer on the network may query the intermediate device in order to determine the security parameters (e.g. to determine whether encryption is on or off, or the level of encryption, for example). Alternatively, as opposed to a query from the login server, or the directory services, the intermediate device may, on its own initiative, may transmit the level of security, security parameters, and/or communication parameters, any of which may be utilized to control the level of access of the computing devices to the network resources.

In this embodiment, where the controlling of a level of access of the computer or the computing devices 2 and 6 to the network resources is performed by the login server 30, network operating system, and/or directory services, the intermediate device may be implemented as a bridge, or as a bridge which interfaces two wireless devices. Thus, in this embodiment (or in any embodiment), the intermediate device may be implemented, as an example, using the RoamAbout Wireless LAN or the access point thereof. Such utilization may reduce the cost of the system, if desired. Further, the intermediate device, in this embodiment, may be a bridge, hub, or switch which does not have a routing function therein, and/or may utilize a wired connection between the intermediate device 10 and the computing devices 2 and/or 6. Moreover, a mixture of wired and wireless connections may be utilized as the connections 4 and 8, and also the connections may utilize various levels of security.

As yet another embodiment of the invention, a separate firewall device may be disposed between the network 12A of FIG. 1A and the network 12B of FIG. 1B.

Referring to FIG. 5, there is illustrated a firewall device 140 connected between the networks 12A and 12B. This firewall device is utilized to restrict or filter the information or network packets which pass between the computing devices and the network resources. As an example of a firewall device which may be utilized as the firewall device 140, the SonicWALL XPRS2, which is incorporated herein by reference, may be utilized as a stand-alone firewall device connecting the networks 12A and/or 12B. Additionally, the firewall device 140 may be implemented using any desired structure or firewall device such as a computing device running the appropriate software, or a routing device routing the appropriate software which restricts or controls access to the network resources.

In this embodiment, the network 12A may be implemented as a conventional computer network, or may be implemented using any type of computer communication device or interface such as by using a computer bus, a serial connection, a parallel connection, a Universal Serial Bus connection, a firewall connection, a wire connection, or any desired type of connection. In the embodiment in which there is a stand-alone firewall device 140 connected between 12A and 12B, the step of determining a level of security of the computer network connection between the computing devices and the intermediate device 10 may be performed by the intermediate device 10. The intermediate device 10 has stored therein information indicating the type of connection between the computing devices 2 and 6 and itself. Thus, the intermediate device 10 is capable of transmitting to the stand-alone firewall device 40 information regarding the level of security of the connections 4 and 8. In addition, or as an alternative to the intermediate device determining the level of security, the firewall device 140 may query the intermediate device 10 in order to determine the level of security of the computer network connection. Moreover, the firewall device 140 may be utilized with the embodiment where the directory services or operating system controls the level of access to the network resources. Moreover, the present invention includes embodiments which are combinations of any of the above embodiments.

With regard to the present invention, it is possible to have the WEP encryption for the computing device 2 turned on while the WEP encryption for the computing device 6 turned off, if desired. However, it is also possible to have WEP encryption for both computing devices turned on. If encryption is used for more than one of the computing devices, it is possible, or desirable, that a different encryption key is utilized for each user. Such encryption keys may be assigned by a network administrator.

When a computing device uses the appropriate security level or encryption, such computing device may have full access to the network. This means that such computing device may utilize or have access to all of the TCP (Transmission Control Protocol) and UDP (User Datagram Protocol) protocols. Such a user may be permitted to perform web browsing, file transfer using FTP, and a Windows file share, if desired.

The present invention may be implemented using any type of communication, computing, transmitting, and/or firewall device which is desired to be used. The various functions described herein can be implemented using general purpose microprocessors, computers, or programmable logic or circuitry programmed to perform the teachings of the invention and/or special purpose hardware or circuitry, or combinations thereof. The software or firmware coding for such devices can readily be prepared by skilled programmers or engineers based on the teachings of the present disclosure, as will be apparent to those skilled in the art. The invention may also be implemented by the preparation of application specific integrated circuits, programmable logic arrays, or by connecting an appropriate network of conventional component circuits, as will be readily apparent to those skilled in the art.

The present invention also includes a computer program product which is a storage medium including instructions which can be used to program a computer to perform a process of the invention. The storage medium can include, but is not limited to, any type of disk including floppy disks, optical disks, CD-ROMs, and magneto-optical disks, ROMs, RAMs, EPROMs, EEPROMs, flash memory, magnetic or optical cards, or any type of media suitable for storing electronic instructions. The invention also includes a memory such as any of the described memories herein which store data structures corresponding to the computer program product of the invention.

Obviously, numerous modifications and variations of the present invention are possible in light of the above teachings. It is therefore to be understood that within the scope of the appended claims, the invention may be practiced otherwise than as specifically described herein.

1. A method of controlling a network, comprising the steps of:
establishing a computer network connection between a computer and an intermediate device which has network resources connected thereto;
determining a level of security of the computer network connection; and
controlling a level of access of the computer to the network resources using the level of security of the computer network connection which has been determined.

2. A method according to claim 1, wherein said step of establishing comprises:
establishing a wireless computer network connection.

3. A method according to claim 1, wherein said step of establishing the wireless computer network connection comprises:
establishing a wireless computer network connection which conforms to an IEEE 802.11b standard.

4. A method according to claim 1, where the step of determining a level of security comprises:
determining whether the computer network connection is encrypted.

5. A method according to claim 1, wherein the step determining whether the computer network connection is encrypted comprises:
determining whether the computer network connection is encrypted using Wired Equivalent Privacy (“WEP”) encryption.

6. A method according to claim 1, wherein the step of controlling a level of access further comprises:
allowing the computer to access a file server which is one of the network resources, only when the step of determining the level of security determines that the computer network connection is encrypted.

7. A method according to claim 6, wherein the step of controlling a level of access further comprises:
allowing the computer to access the Internet which is one of the network resources, regardless of whether the computer network connection is encrypted.

8. A method according to claim 7, wherein the step of controlling a level of access further comprises:
allowing the computer to access an email server which is one of the network resources, regardless of whether the computer network connection is encrypted.

9. A method according to claim 7, wherein the step of controlling a level of access further comprises:
allowing the computer to access an email server which is one of the network resources, only when the computer network connection is encrypted.

10. A method according to claim 1, wherein:
the step of determining is performed by the intermediate device, and
the step of controlling is performed by the intermediate device.

11. A method according to claim 10, wherein:
the step of determining is performed by the intermediate device which is a router.

12. A method according to claim 11, wherein:
the step of controlling is performed by the intermediate device which is a router having a firewall operation.

13. A method according to claim 12, wherein:
the step of establishing is performed using the intermediate device which is a router which establishes a wireless connection to the computer.

14. A method according to claim 1, wherein:
the step of determining is performed by a server running a network operating system, the server being different from the intermediate device, and
the step of controlling is performed by the server running the network operating system.

15. A method according to claim 14, wherein:
the step of determining is performed by the server which is running a network directory service.

16. A method according to claim 14, wherein:
the step of establishing is performed by a bridge connected to the computer through the computer network connection.

17. A method according to claim 16, wherein:
the step of establishing is performed by the bridge connected to the computer through the computer network connection which is a wireless network connection.

18. A method according to claim 1, wherein the step of controlling comprises:
controlling the level of access by a stand-alone firewall device which is connected between the intermediate device and the network resources.

19. A method according to claim 18, wherein the step of determining comprises:
determining the level of security using the intermediate device.

20. A method according to claim 18, wherein the step of establishing comprises:
establishing the computer network connection as a wireless connection using the intermediate device.

21. A system for controlling a network, comprising:
means for establishing a computer network connection between a computer and an intermediate device which has network resources connected thereto;
means for determining a level of security of the computer network connection; and
means for controlling a level of access of the computer to the network resources using the level of security of the computer network connection which has been determined.

22. A system according to claim 21, wherein said means for establishing comprises:
means for establishing a wireless computer network connection.

23. A system according to claim 21, wherein said means for establishing the wireless computer network connection comprises:
means for establishing a wireless computer network connection which conforms to an IEEE 802.11b standard.

24. A system according to claim 21, where the means for determining a level of security comprises:
means for determining whether the computer network connection is encrypted.

25. A system according to claim 21, wherein the step determining whether the computer network connection is encrypted comprises:
means for determining whether the computer network connection is encrypted using Wired Equivalent Privacy (“WEP”) encryption.

26. A system according to claim 21, wherein the means for controlling a level of access further comprises:
means for allowing the computer to access a file server which is one of the network resources, only when the means for determining the level of security determines that the computer network connection is encrypted.

27. A system according to claim 26, wherein the means for controlling a level of access further comprises:
means for allowing the computer to access the Internet which is one of the network resources, regardless of whether the computer network connection is encrypted.

28. A system according to claim 27, wherein the means for controlling a level of access further comprises:
means for allowing the computer to access an email server which is one of the network resources, regardless of whether the computer network connection is encrypted.

29. A system according to claim 27, wherein the means for controlling a level of access further comprises:
means for allowing the computer to access an email server which is one of the network resources, only when the computer network connection is encrypted.

30. A system according to claim 21, wherein:
the means for determining is the intermediate device, and
the means for controlling is the intermediate device.

31. A system according to claim 30, wherein:
the means for determining is the intermediate device which is a router.

32. A system according to claim 31, wherein:
the means for controlling is the intermediate device which is a router having a firewall operation.

33. A system according to claim 32, wherein:
the means for establishing is the intermediate device which is a router which establishes a wireless connection to the computer.

34. A system according to claim 31, wherein:
the means for determining is a server running a network operating system, the server being different from the intermediate device, and
the means for controlling is the server running the network operating system.

35. A system according to claim 34, wherein:
the means for determining is the server which is running a network directory service.

36. A system according to claim 34, wherein:
the means for establishing is a bridge connected to the computer through the computer network connection.

37. A system according to claim 36, wherein:
the means for establishing is the bridge connected to the computer through the computer network connection which is a wireless network connection.

38. A system according to claim 21, wherein the means for controlling comprises:
a stand-alone firewall device which is connected between the intermediate device and the network resources.

39. A system according to claim 38, wherein the means for determining comprises:
means for determining the level of security using the intermediate device.

40. A system according to claim 38, wherein the means for establishing comprises:
means for establishing the computer network connection as a wireless connection using the intermediate device.
